(19) United States
(12) Patent Application Publication
(10) Pub. No.: US 2009/0282136 A1
(43) Pub. Date: Nov. 12, 2009

(54) Automatic Generation of Web Service client for Web Services Interoperability Testing

(75) Inventor: Velmurugan Subramanian, Bangalore (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 12/371,933

(22) Filed: Feb. 17, 2009

Related U.S. Application Data
(60) Provisional application No. 61/051,352, filed on May 8, 2008.

(51) Int. Cl. G06F 15/177

(52) U.S. Cl. 709/222

(57) ABSTRACT

Automatic generation of a client program such as Web service client source code for a client application for enabling the client application access to the Web service, for testing interoperability of the client application with the Web service. The Web service client source code is automatically generated for different execution environments of the client application. In one embodiment, the Web service client source code is generated by analyzing a proxy code where the proxy code may be generated from a WSDL file that may describe various operations provided by the Web service. Alternatively, the Web service client source code may be generated based on configuration information that may provide data indicating the context in which the Web service client source code may be generated. Further, automatic generation of the test data to be sent from the client application to the web service in an interoperability test is also provided.

### RELATED APPLICATION

The present application is related to the co-pending U.S. Provisional Patent Application Ser. 61/051,352, entitled, “Automatic Generation of Web service client for Web Services Interoperability Testing”, filed on 8 May 2008, attorney docket number: ORCL-082, naming as inventor: Velmurugan Subramanian, and is incorporated in its entirety herewith.

### BACKGROUND OF THE INVENTION

1. Field of the Invention

The present invention generally relates to Web Services testing environment and more specifically to automatically generating Web service client for Interoperability testing.

2. Related Art

Web service is standards based solution that offers services interoperable between different software applications, running on a variety of platforms and distributed across the Internet. In simple terms, a Web service is an application component or a software component available on the web, making known its intended function, communicating using open protocols and ready to be used by others in their application. A few simple examples of a Web service may be a calculator, currency converter where the functionalities of the services are exposed by a Web service provider on the web and may be accessed and their services utilized by Web service consumers or Web service clients. Web services may use Simple Object Access Protocol (SOAP) for exchanging information in the distributed environment and make known their intended function by exposing through a public interface all the methods available to consumers to access the service. Such an interface definition may be accomplished using the standard Web Service Description Language (WSDL), which is a XML grammar. Once created, the Web service also includes mechanism for consumers to locate the service and its public interface. One such mechanism is Universal Description, Discovery and Integration (UDDI) that is a well-known directory of Web services. At the core, the Web service protocol stack may include a set of protocols used to define, locate, implement the Web service and make different web services interact with each other. This core protocol stack consists of four layers: Service Transport, XML messaging, Service Description, and Service Discovery.

Although Web services standard was developed to enable interoperability between services deployed on different platforms or environments, different implementations of Web service standards from different vendors using different set of technologies has lead to interoperability issues. A few examples of commercially available Web service stacks are the Oracle® AS Web services Stack, Microsoft® .Net Web Services, etc. Interoperability testing tests whether a client application consuming the Web service can run against the Web service, where, for instance the client application and the Web service may be built on different environments or technologies, using different programming languages, or based on different product versions. Testing a Web service stack for interoperability can be a very engaging task for a developer involved in testing interoperability, considering that the Web service protocol stack is very complex and there may be many test scenarios in different areas of the Web service such as messaging, WS-security, transactions, etc.

Therefore, what is needed is, a technique to assist in Web services interoperability testing making it more efficient, and reducing manual effort required of the developer.

### BRIEF DESCRIPTION OF THE DRAWINGS

Embodiments of the present invention will be described with reference to the accompanying drawings briefly described below.

FIG. 1A is a block diagram illustrating a typical environment for testing Web services interoperability.

FIG. 1B is a flow diagram illustrating the process involved in testing Web services interoperability according to prior art.

FIG. 2A is a block diagram illustrating an environment for testing Web services interoperability in which a system according to an embodiment of the present invention is operable.

FIG. 2B is a flow diagram illustrating the process involved in testing Web services interoperability according to an embodiment of the present invention.

FIG. 3 is an example scenario for testing interoperability between web services and illustrating an embodiment of the present invention.

FIG. 4 is a sample test page generated for a developer to enter test data used in testing the Web service interoperability according to an embodiment of the present invention.

FIG. 5 is a sample graphical user interface for providing the configuration information for generating the Web service client source code according to an embodiment of the present invention.

FIGS. 6A-6C together shows a portion of a proxy code generated for a .Net environment using a proxy code generator with inputs from a WSDL file.

FIG. 7A-7B together shows portions of the Web service client source code generated automatically according to an embodiment of the present invention for a .Net environment in C# programming language.

FIG. 8A-8B together shows portions of the Web service client source code generated automatically according to an embodiment of the present invention for a Java Runtime Environment.

FIG. 9 is block diagram illustrating the details of digital processing system in which various aspects of the present invention are operative.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

1. Overview

An aspect of the present invention provides a technique to automatically generate a client program such as Web service client source code for a client application for enabling the client application access to the Web service, where the client application may refer to any application being tested for interoperability against the Web service. The technique, as described in the present invention, is capable of automatically generating the Web service client source code for different execution environments of the client application. According to one aspect of the present invention the Web service client source code is generated automatically by analyzing a proxy code where the proxy code may be generated from a WSDL file that may describe various operations provided by the Web service.

According to another aspect of the present invention the Web service client source code may be generated based on configuration information that may provide data indicating the context in which the Web service client source code may be generated. The context provides the background for generating various parts of the Web service client source code. In simple terms the context is the settings based on which portions of the Web service client source code may be generated. The settings may correspond to different test scenarios that may be incorporated in portions of the Web service client source code. In one embodiment of the present invention the context for generating the Web service client source code may allow incorporating test scenarios possible for different areas of the Web service such as Schema, messaging, security, etc., thus enabling interoperability testing for various operations of the Web service. Another aspect of the present invention provides a graphical user interface (GUI) to enable a user to provide the context, such as the scenarios, in which the Web service client source code may be generated.

A part of generating the Web service client source code automatically also involves generating test data to be sent from the client application to the Web Service in an interoperability test wherein the test data may be generated based on the data types required by the Web service and as defined in the WSDL. Another embodiment of the present invention enables the developer to specify the test data required to be sent from the client application to the Web service. The developer may be presented with an HTML based test page to enter the test data.

Since the generation of the Web service client source code is automatic, according to an aspect of the present invention, various scenarios of interoperability can be easily tested without the application developer having to manually code the Web service client source code for each of the different Web service stacks available from different venders, for each scenario, and for each interoperability test. Moreover, Web services interoperability can be tested without knowledge of programming languages such as Java, C#, etc. Several advantages of the technique of the present invention may be apparent from the embodiments of the present invention below.

According to several embodiments of the present invention, multiple client programs (Web service client source code) may be automatically generated in several different conditions. For example, according to some embodiments of the present invention more than one client program may be automatically generated for a client application, each client program automatically generated for a different web service by analyzing the proxy code corresponding to that web service. Thus this enables interoperability testing of a client application with different web services without the application developer having to manually code the client program for each interoperability test.

According to some embodiments of the present invention, multiple client programs (Web service client source code) may be automatically generated for a client application, each client program automatically generated based on different sets of configuration information and each set of configuration information may include different contexts for generating the client programs. Thus this enables interoperability testing of a client application with a web service for different test scenarios or operations of the web service without the application developer having to manually code the client program for different test scenarios or operation of the web service.

Several embodiments of the present invention, enable interoperability testing of multiple client applications with multiple web services by analyzing each of the proxy programs corresponding to each of the web services and automatically generating multiple client programs for each client application and web service pair involved in an interoperability test. Thus this enables interoperability testing of multiple client applications with multiple web services without the developer having to manually code the client program for each client application and web service pair in an interoperability test.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

2. Example Environment

Some or all of the figures below have been explained with reference to an example when required.

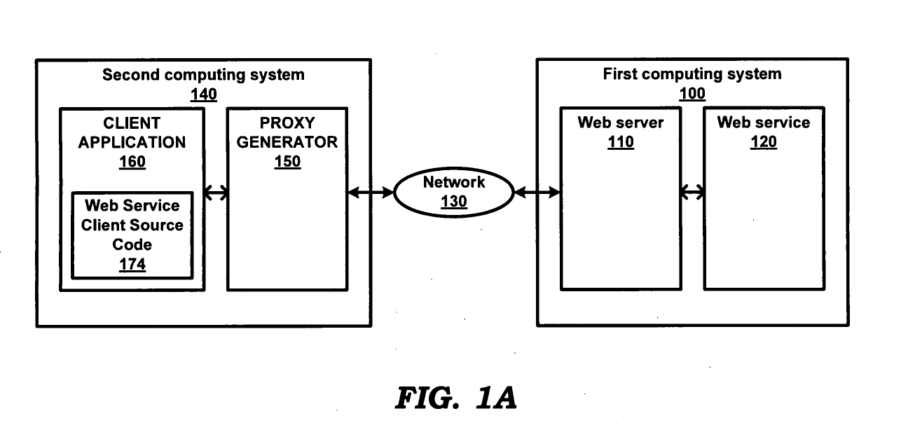

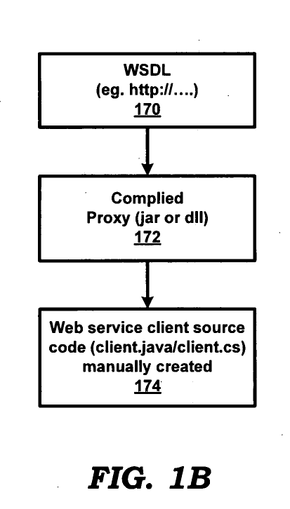

FIG. 1A is a block diagram illustrating a typical environment for testing Web services interoperability as in the prior art and includes a first computing system 100 comprising a Web server 110 and hosting a Web service 120, a network 130, a second computing system 140 comprising a proxy generator 150 and a client application 160 executing on the second computing system 140.

Web service 120 on the first computing system 100 refers to a Web service implementation of an application component or functionality, which can be identified by a Universal Resource Identifier (URI) and whose interfaces and binding can be defined, described, and discovered by XML artifacts. The Web service's functionality and attributes are exposed for use by the Web service consumer by providing a WSDL file. WSDL is an XML document that describes the Web services, such as the location of the service and the operations or methods that are available for a consumer interested in using the Web service and may be published or accessible as a URL over the network 130 through the Web server 110. The WSDL file can be generated automatically using existing tools such WebServiceAssembler tool from Oracle Corporation of Redwood Shores, using the artifacts, such as Java classes, Enterprise Java Beans, PL/SQL procedures etc., from an existing implementation of the application component. The Web service 120 may be generated using a Web service stack based on one of the many standard Web service specifications.

Web server 110 as is well known in the related art is a program that serves web pages and communicates on the network 130 using standard HTTP protocol. Network 130 provides connectivity between the first computing system 100 and the second computing system 140 and may be implemented using protocols such as the Internet Protocol (IP) well known in the relevant art.

Proxy generator 150 is specific to the environment of execution of the client application 160 and creates an intermediate proxy that acts as a proxy for the service described in the WSDL file. The proxy generator tool such as the WebServiceAssembler tool from Oracle Corporation of Redwood Shores, uses the WSDL file as an input and generates the proxy code which are program templates enabling a local program of the client application 160 to access the operations or methods described in the WSDL. The proxy code basically converts the service description in the WSDL file into structures in a programming language interface, such as an application program interface (API) as understood by the client application 160. The generated proxy code may be bound to the HTTP transport and XML-based SOAP protocol.

The client application 160 is the application that is being tested for interoperability with the Web service 120 and may be any web application client or a client generated from a Web service stack based on one of the many standard Web service specifications. The Web service client source code 174 is the local program of the client application 160 and includes code that invokes the operations of the Web service 120 through the proxy code. The Web service client source code 174 is typically created by an application developer local to the client application 160, is further compiled to generate the Web service client. In a typical interoperability testing, the Web service 120 echoes the test data sent from the Web service client, indicating a successful interoperability test.

FIG. 1B illustrates the process flow in testing Web services interoperability according to prior art.

The generation of the WSDL 170 from the Web services 120 is well known in the art, for example, using WebServiceAssembler tool from Oracle Corporation of Redwood Shores and is not discussed in detail here. Once the services are deployed at a web server with a URI, the WSDL file can then be retrieved by sending HTTP request to the URI, with the string ‘?wsdl’ (querying for WSDL) appended (e.g., http://simple.com/?wsdl).

The proxy code 172 may be generated using the proxy generator 150 specific to the environment of execution of the client application 160, thus generating the proxy code 172 in a programming language supported by the environment of execution of the client application 160. The proxy generator 150 such as the WebServiceAssembler tool from Oracle Corporation of Redwood Shores takes the WSDL file 170 generates the proxy source code that includes classes and methods defined based on the description of the functionality of the Web service 120 in the WSDL file 170. The proxy source code is then compiled to generate the proxy code 172. The proxy code 172 marshals the parameters received from the client application programming language interface to XML format transportable over the network 130 and unmarshals the incoming XML formatted data back into the programming language parameters. The rules for mapping between the programming language and XML type are stored in a mapping file, which can be used by the proxy code 172.

The client application developer refers this generated proxy code 172 and manually writes/codes substantial portions of the Web service client source code 174 for the client application 160. The Web service client source code 174 is designed to invoke methods in the proxy code 172, using programming language interface and by providing the necessary parameters. The proxy code 172 marshals the parameters and sends them as XML over HTTP to the Web server 110. The client application developer writes code (Web service client source code 174) that at least creates a local instance of the classes defined in the proxy code 172 and that invokes the methods defined in the proxy code 172 with the appropriate parameters to send requests to the Web service 120.

Currently, as described above the Web service client source code 174 is manually written by the client application developer from the proxy code 172 and compiled to generate the Web service client that can invoke the Web service 120. The process of creating the Web service client manually can be a very engaging task for the client application developer in especially interoperability testing considering that there are several Web service stacks available from several different vendors as discussed above and in order to test a client application against each Web service stack for different policies and operations of the Web service stack, the developer has to manually create the Web service client for each for each Web service stack for each interoperability test. Further, there may be different client applications to be tested against the Web services and the client applications may be based on different environments or platforms, technologies (.Net, Java) and programming languages such as Java, C#, etc, thus requiring the developer to have extensive knowledge in various programming languages in order to create the Web service client.

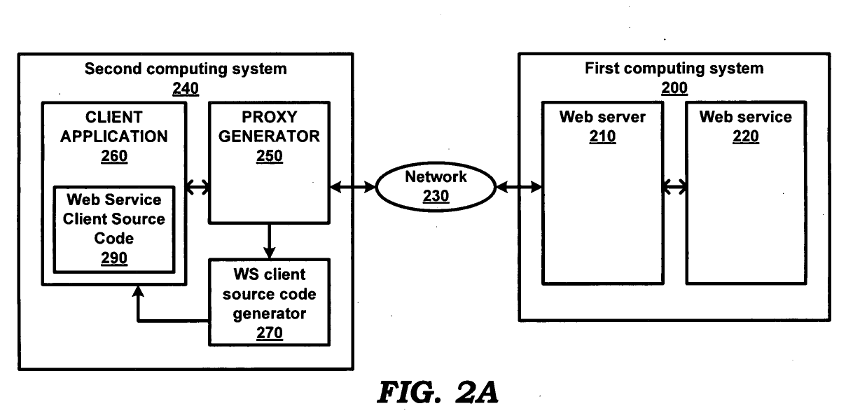

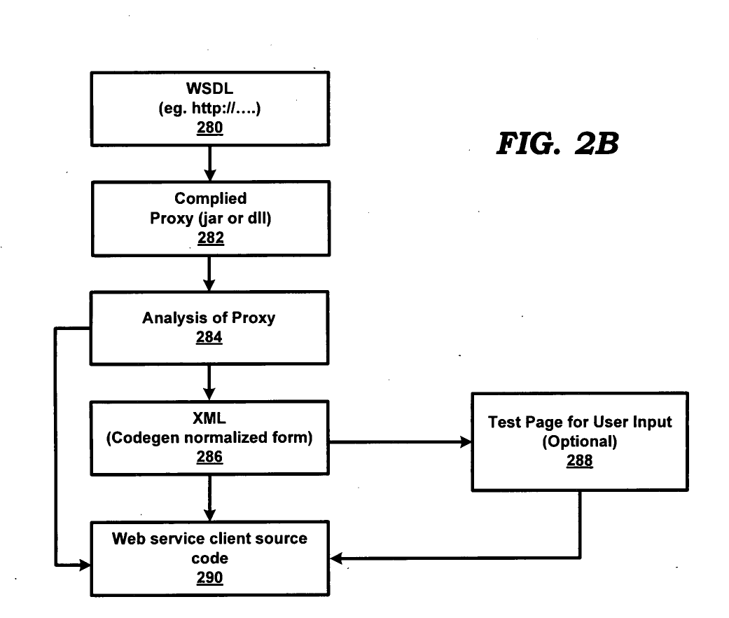

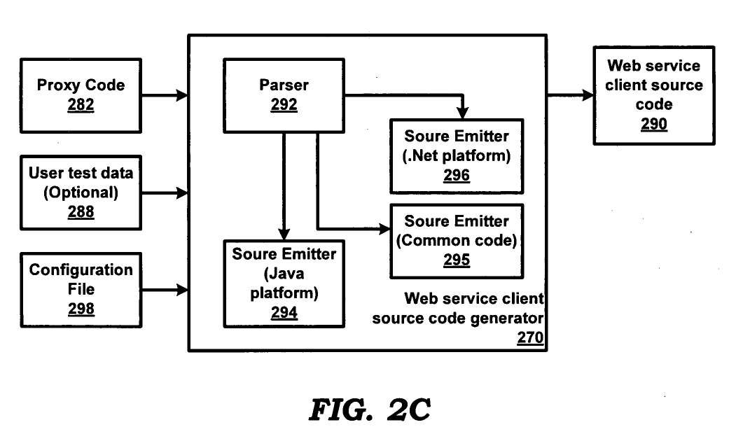

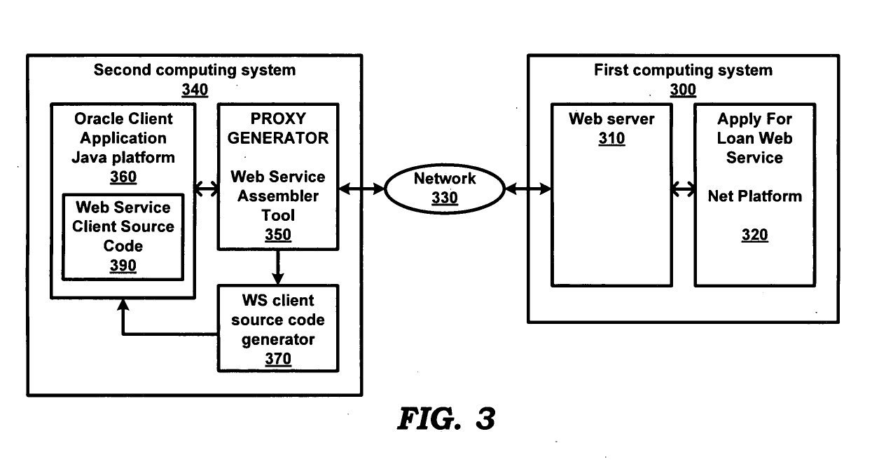

FIG. 2A is a block diagram illustrating an environment for testing Web services interoperability according to an embodiment of the present invention and FIG. 2B illustrates the flow of the process involved in testing Web services interoperability according to an embodiment of the present invention. FIGS. 2A and 2B are explained in further detail below with reference to an example according to an embodiment of the present invention as illustrated in FIG. 3. Although, FIG. 2A illustrates a typical environment for testing Web services interoperability it may be apparent to one skilled in the relevant art that the invention may be applicable to any other environment with different or modified components as in FIG. 2A but designed for Web services interoperability testing.

In FIG. 2A the first computing system 200 comprising the Web service 220 and the Web server 210, the network 230, and the proxy generator 250 are equivalent to the first computing system 100 comprising the Web service 120 and the Web server 110, the network 130, and the proxy generator 150 of FIG. 1A. In FIG. 2A, Web service 220 on the first computing system 200 may refer to a Web service implementation of an application component that may expose its services and attributes through the WSDL file shown as 280 in FIG. 2B, which may be made available as a URL on the network 230 through the Web server 210. The second computing system 240 comprises a proxy generator 250, client application 260 and a Web service client source code generator 260. The proxy generator 250 generates proxy code 282 of FIG. 2B using the WSDL file 280 as an input to generate the proxy code 282.

According to an aspect of the present invention, the Web service client source code generator (hereafter WS client code generator) 270 automatically generates the Web service client source code 290 for the client application 260. The WS client code generator 270 generates Web service client source code 290 in a programming language (such as Java, C#) supported for execution on the environment of the client application 260 (such as Java, .Net), and based on the testing scenario. Thus, the WS client code generator 270 provides support for more than one platform such as Java and .Net.

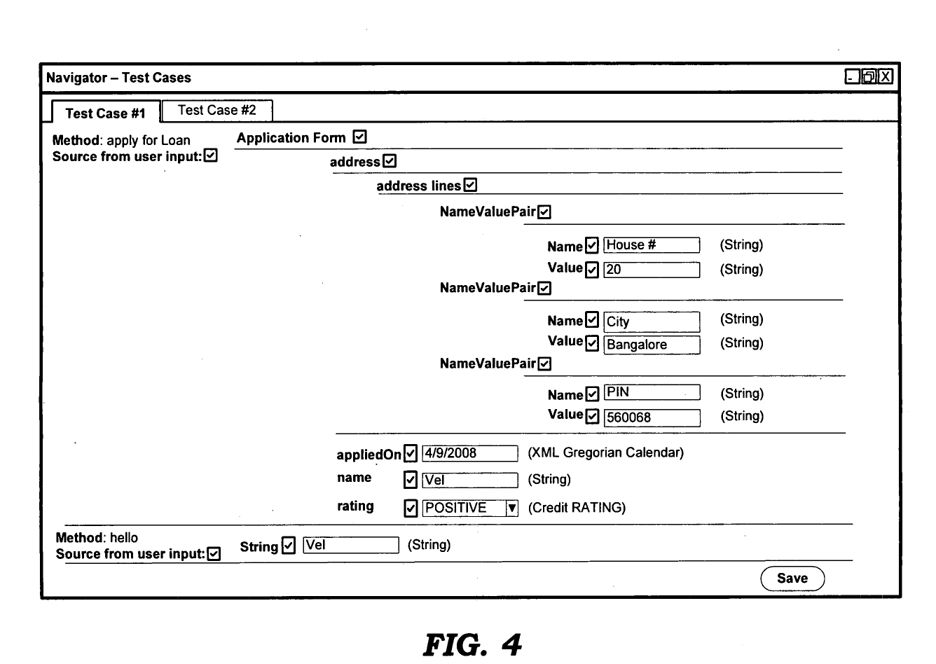

According to another embodiment of the present invention, the WS client code generator 270 analyzes the proxy code 282 and generates a HTML based test page 288 for the application developer to enter test data that may be sent from the client application 260 to the Web service 220. The type of test data to be entered on the test page 288 may be generated based on the argument types required for the methods in the proxy code 282. FIG. 4 illustrates an example test page generated according to an embodiment of the present invention.

In the example of FIG. 3, the Web service 220 is a ApplyForLoan Web service 320 developed using Microsoft™ .NET framework, the client application 260 is a Java based Oracle client 360 or may be generated from Oracle®AS Web service stack, and the proxy generator 250 is the WebServiceAssembler tool 350 from Oracle Corporation of Redwood Shores that is capable of generating a proxy code with an input such as a WSDL file shown in Appendix B representing the services and attributes of the ApplyForLoan Web service 320.

The WS client code generator 370 according to an embodiment of the present invention generates the Web service client source code 390 for Java Runtime Environment and in Java programming language to enable access to the Web service and according to an aspect of this invention enable interoperability testing of Java based Oracle client 360 against .Net Web service 320.

FIG. 2C is a block diagram illustrating the components of the WS client code generator 270 (WS client code generator 370 according to the example embodiment) according to an embodiment of the present invention and is later explained with reference to the example illustrated in FIG. 3. The WS client code generator 270 includes a parser 292 and a set of source emitters 294, 295, and 296 that include emitter hierarchy of classes that emit runnable Web service client source code 290 for different client application execution environments and programming languages. For example, the source emitter 294 in FIG. 2C is selected in the case where the client application 260 is based on Java and the source emitter 296 is selected in the case where the client application 260 is based on .Net environment and the source emitter 295 is responsible for emitting a part of the Web service client source code that may be common to all the Web service stacks. In general, the source emitter is capable of generating source code for more than one client application platforms execution environments and programming languages. Although FIG. 2C indicates source emitters for Java and .Net based environment, it may be appreciated that the invention may be extended to other such as C, C++ based environments.

In one embodiment of the present invention the WS client code generator 270 may be provided with a configuration file 298, such as shown in Appendix A, that includes data in the context of which the Web service client source code 290 may be generated. In an example embodiment, the configuration file 298 includes data related to the test scenarios to be included in an interoperability test, for example, WS-Addressing policy, MTOM (Message Transmission Optimization Mechanism) policy, Reliable Messaging, etc to be incorporated in the Web service client code for testing interoperability. Additionally, the configuration file may also include data indicating the location of the proxy code 282 and data indicating the programming language and the environment of execution of the client application 260 where the Web service client source code 290 may be executed.

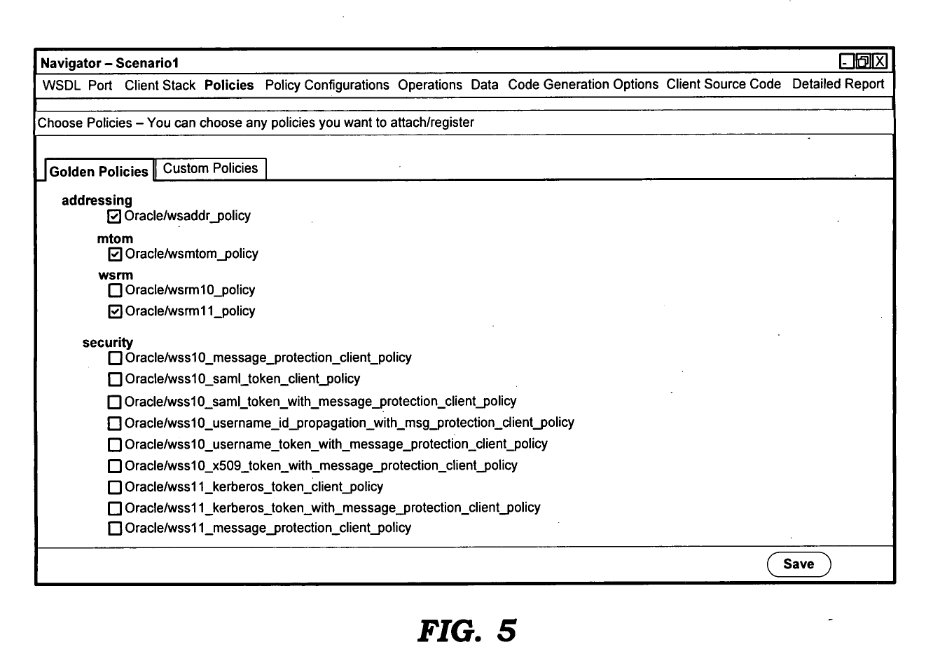

The configuration file 298 may be created manually or automatically by providing a page as illustrated in the graphical user interface of FIG. 5, where the page enables the developer to provide the configuration information by selecting the different policies, operations, etc to be incorporated in the Web service client source code 290. Once the developer makes the selections on the GUI of FIG. 5, the configuration file 298 is generated such as in XML format. Thus, this allows the developer to efficiently select different areas and operations of the Web service 220 stack for testing interoperability without requiring much manual effort from the developer in creating the Web service client source code for different test scenarios.

In another embodiment of the present invention the WS client code generator 270 locates the proxy code 282 based on the Web service port provided by the application developer, for example, in the configuration file 298. The parser 292 loads the proxy code 282 and parses the proxy code 282, against methods, arguments and return types, step 284 of FIG. 2B as described in more details in section 3 below.

In another embodiment of the present invention, source emitter 294 or source emitter 296 may be selected depending on the execution environment of the client application 260, for example, the selection may be based on the data in the configuration file 298 indicating the programming language and execution environment of the client application 260. The source emitter 295 may be responsible for emitting a part of the Web service client source code that may be common to all the Web service stacks. The parser 292 invokes the methods that are available in these emitters.

According to another embodiment of the present invention, when the parser 292 parses the proxy code 282, it identifies the argument types required for the methods in the proxy code 282 and accordingly the WS client code generator 270 automatically generates the test data (parameters corresponding to the argument types) that is embedded in the Web service client source code 290 and sent to the Web service 220 in an interoperability test. The manner in which the parser 292 generates the test data is further described according to an example embodiment in section 3 below.

According to another embodiment of the present invention, the output from the parser 292 in FIG. 2C may be converted to an XML file 286 shown in FIG. 2B and may include additional information to generate a HTML based test page 288 for the developer to input the test data. The data input through the test page 288 is included in the Web service client source code 290 and is sent to the Web service 220 during the testing. FIG. 4 illustrates a sample of such an HTML-based test page using which the developer may provide test data for the interoperability testing. The manner in which the parser 292 generates the test page for enabling a user to enter test data is further described according to an example embodiment in section 3 below.

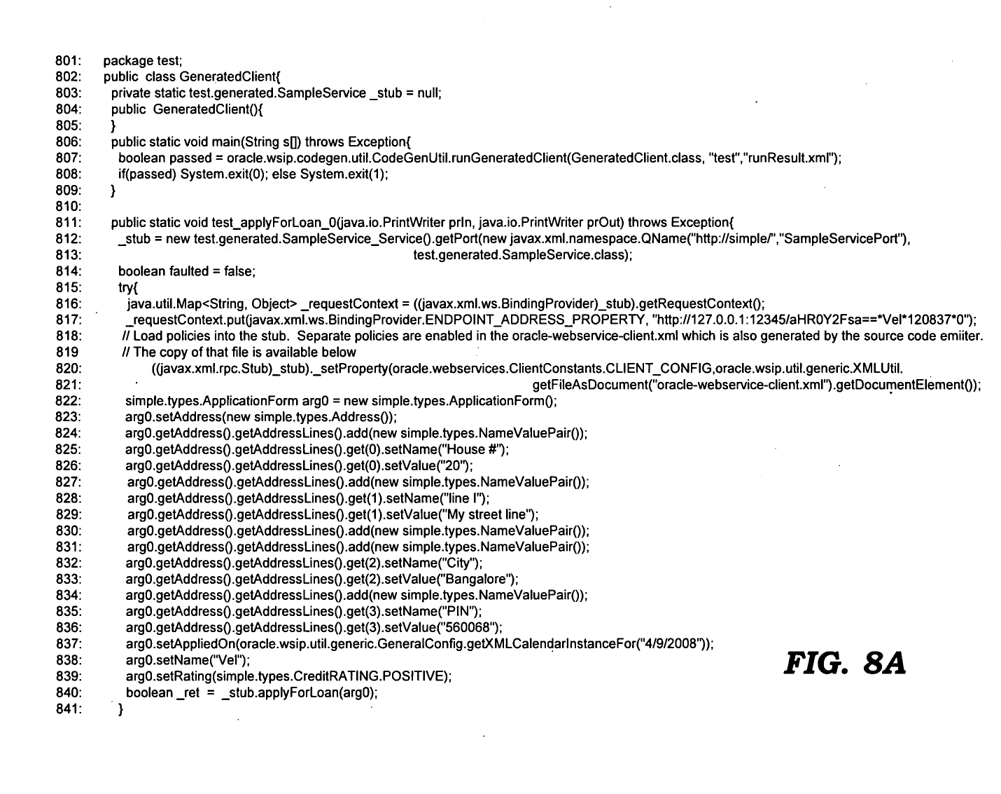

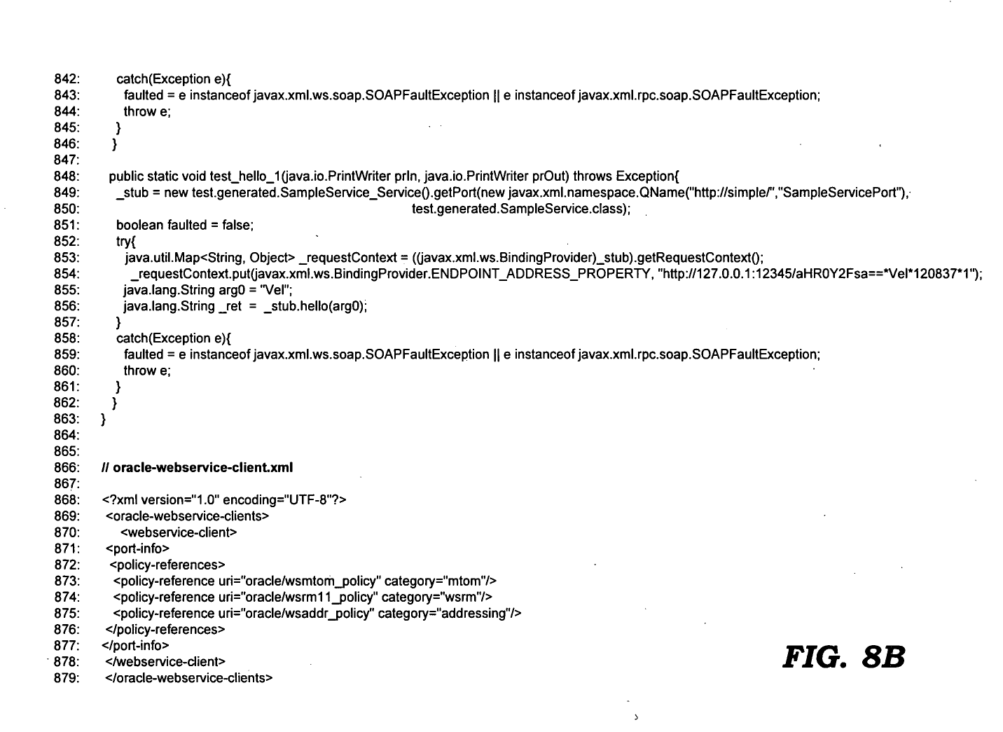

With reference to the example of FIG. 3 illustrating an environment for interoperability testing of Oracle client application 360 against ApplyForLoan Web service 320. The Web service assembler tool 350 generates the proxy code shown in Appendix D using the WSDL file shown in Appendix B. The WS client code generator 370 that comprises a set of source emitters and a parser 292 parses the proxy code in Appendix D and with additional inputs from the configuration file in Appendix A and the test data entered from the test page of FIG. 4, automatically generates the Web service client source code 390 shown in FIGS. 8A-8B. In an alternate embodiment, the parser 292 while parsing the proxy code in Appendix D generated by the Web service assembler tool 350 can generate the test data automatically. Since the client application 360 is a Java based client, the WS client code generator 370 selects source emitter 294 to emit the Web service client source code 390 specific for Java Runtime Environment. The configuration file in Appendix A provides the context for generating the Web service client source code 390 and additionally may provide data indicating the location of the proxy code, and data indicating the programming language and execution environment of the client application 360.

For example, the lines 41-88 in the configuration file of Appendix A enables the WS client code generator 370 to generate a Web service client source code 390 designed for testing interoperability of the client application 360 against the ApplyForLoan Web service 320 in the context of a WS-Addressing policy as may be supported by the ApplyForLoan Web service 320. The portions of the Web service client source code 390 automatically generated by the WS client code generator 370 and corresponding to interoperability test in the context of the WS-Addressing policy is illustrated in FIG. 8A, lines 818-821. Further, the values for the ApplicationForm such as for the address fields in FIG. 8A, lines 822-839 may be derived from the test page input of FIG. 4 or generated by the WS client code generator 370 as described earlier.

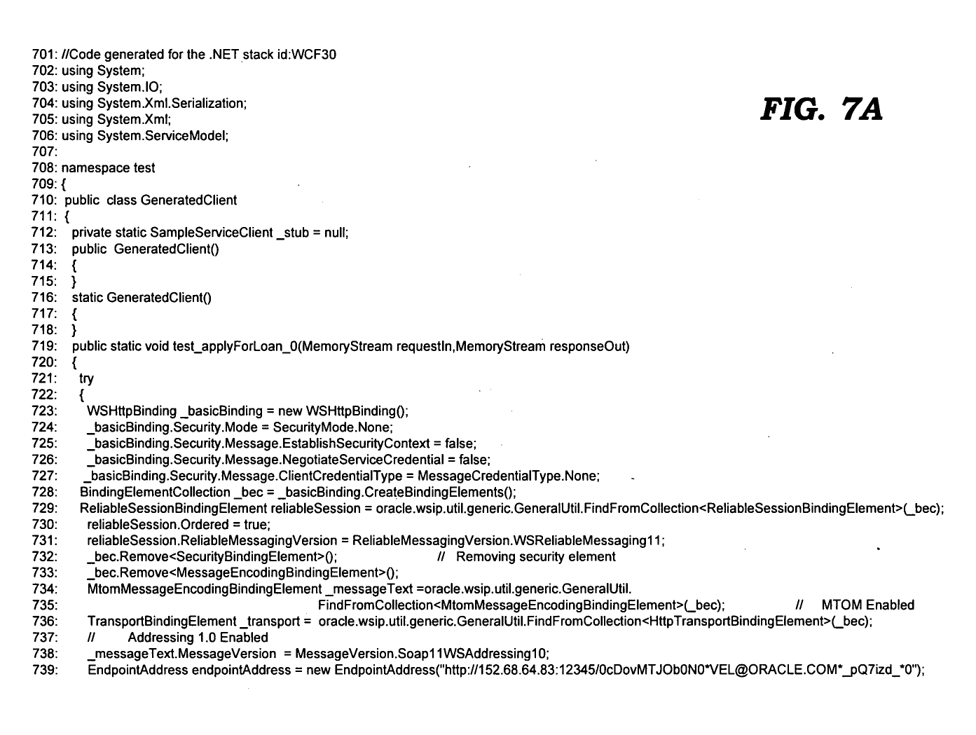

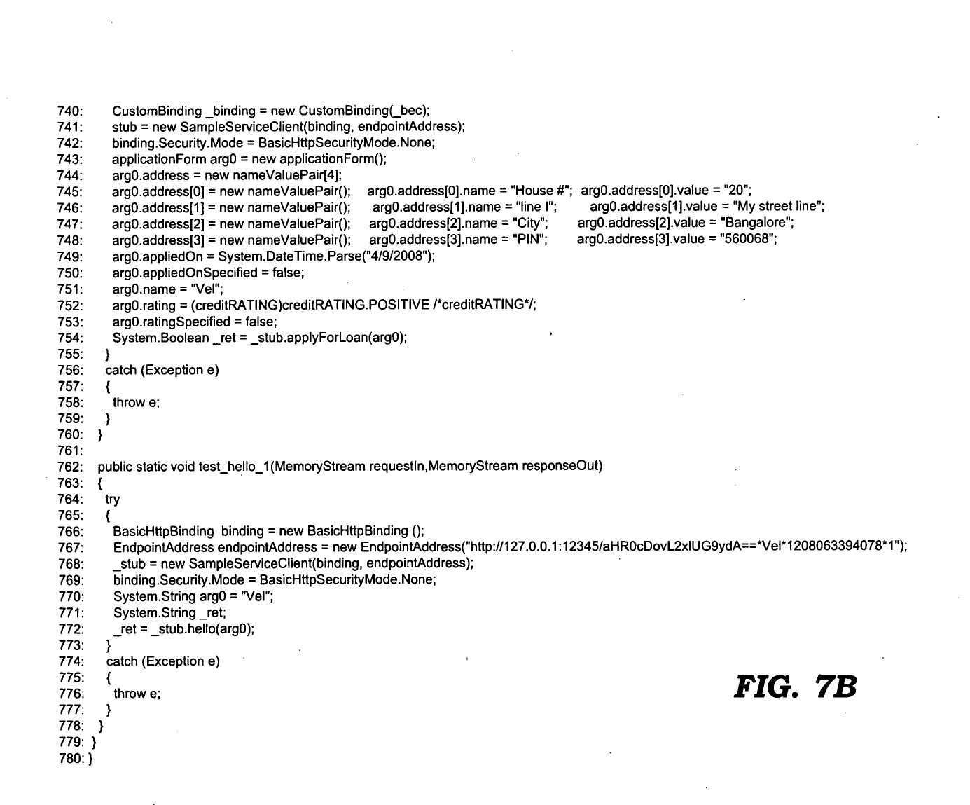

The WS client code generator 270 also includes a source emitter 296 for .Net environment (as shown in FIG. 2C) and that can generate a Web service client source code 290 for a .Net environment such as in C# programming language, Client.cs. This may be required in the example scenario where, the client application 260 is based on .Net framework. A sample of the .Net based Web service client source code 290 generated using the WS client code generator 370 is shown in FIGS. 7A-7B.

Further examples of interoperability testing includes testing an Oracle client against an Oracle Web service stack, testing a .Net client against a .Net based Web service, or testing interoperability for different programming models of the Oracle® AS Web service stack such as testing an JAX-RPC based client of the Oracle® AS Web service stack against a JAX-WS Web service of the Oracle® AS Web service stack.

The Web service client source code 390 generated automatically using the WS client code generator 370 is further compiled and invokes the Web service 320 with the test data and the Web service 320 may echo the test data indicating successful interoperability as in a typical testing scenario. As is well known in the relevant art the messages exchanged between the client application 260 and the Web service 220 during this testing may be captured to analyze the result of the Interoperability test.

3. Conversion

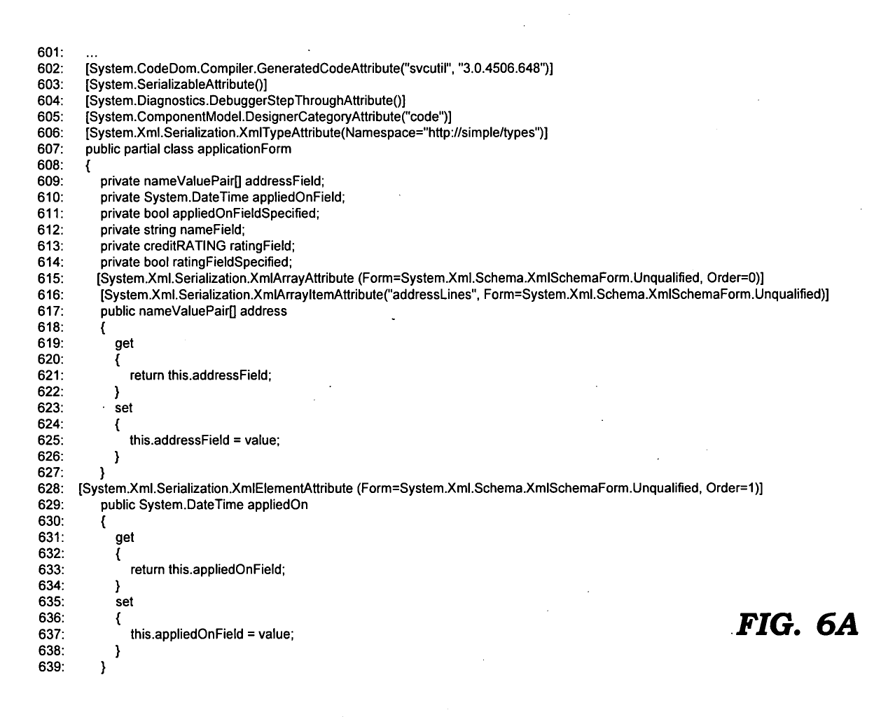

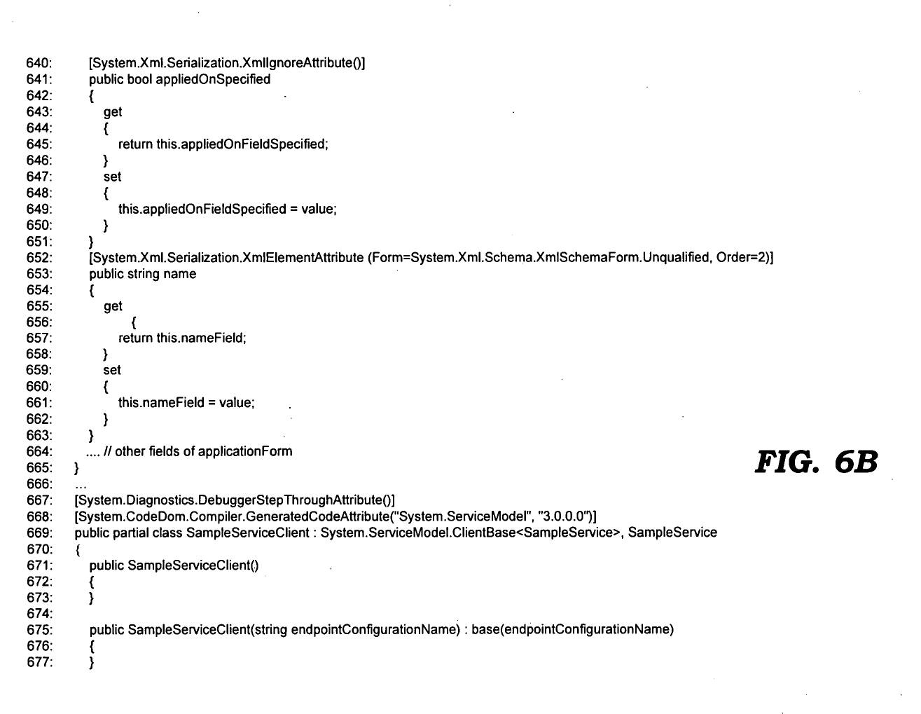

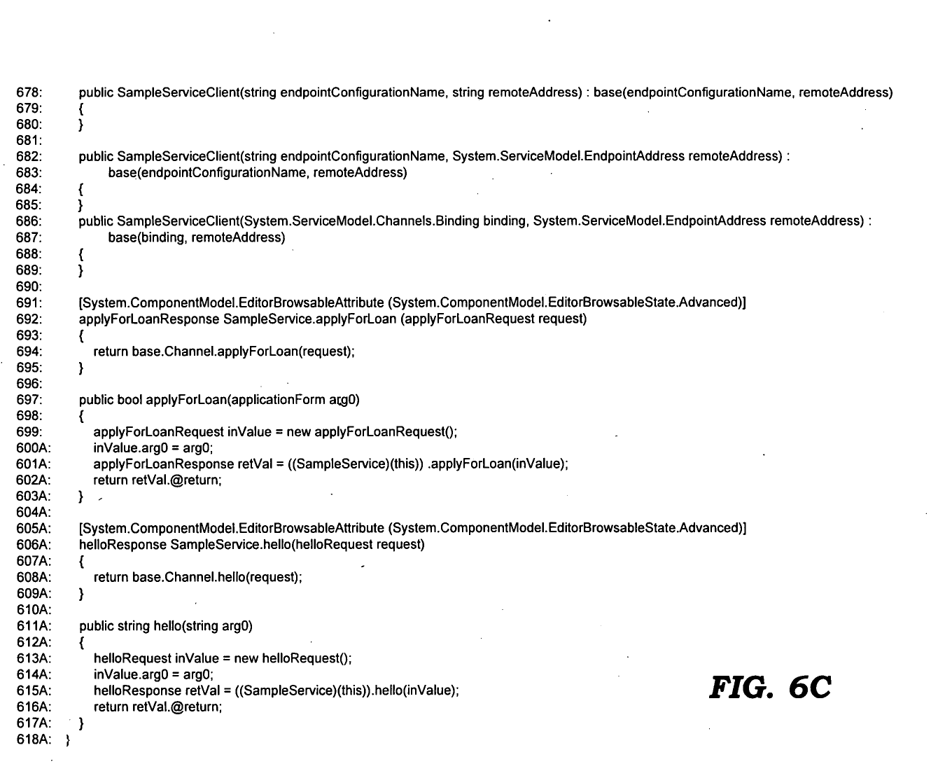

FIGS. 7A-7B together contains a portion of the generated Web service client source code 290 corresponding to a combination of .NET environment and C# programming language in accordance to the configuration file in Appendix A. The WSDL file, based on which the proxy code 282 is generated, is included in Appendix B. The proxy code 282 is shown in Appendix C, while the portions used for description are included in FIGS. 6A-6C.

As may be readily observed, the portion of the Web service client source code 290 in FIGS. 7A-7B operates to test two operations provided by a web service. In particular, lines (code) 719-760 and 762-778 respectively test the “ApplyForLoan” and “hello” operations of the web service using the proxy code 282. The program logic to generate the code of FIGS. 7A-7B (in source emitter 296) is described below briefly.

Lines 740-743 are generated based on the class defined in the proxy code 282, in particular the class that extends “System.ServiceModel.ClientBase” (line 669). Accordingly, WS client code generator 270 determines that the class named SampleServiceClient (see lines 667-618A) (hereafter “client class”) is to be invoked for testing the operations of the web service.

WS client code generator 270 then determines each of the methods in the client class (e.g., using Reflection, well known in .NET type dynamic environments). Therefore the methods in lines 697 (applyForLoan) and 611A (hello) are identified. For conciseness, the description is provided for only one of the methods, applyForLoans corresponding to lines 719-760.

WS client code generator 270 determines that the applyForLoan sub-routine (commonly referred to as a method in the relevant arts) requires an argument of type applicationForm (as indicated in line 697), which is a complex type (implying that it is constituted by other variables according to a structure).

Accordingly, WS client code generator 270 inspects the proxy code 282 for the definition of the applicationForm class (found at 602 to 665). It may be noted that the various fields of the applicationForm class are of other complex types (such as nameValuePair and creditRATING, which are also defined in the proxy code 282).

Thus, WS client code generator 270 continues inspection of the proxy code 282 recursively to determine the manner in which the parameters of the applyForLoan method are to be generated. The recursion may proceed until all the variables are determined to be of simple types (such as integer, double, string, etc.).

Once the manner of generating the parameters of a sub-routine is determined, WS client code generator 270 generates code (lines 743-753), which creates the parameter by injecting data corresponding to the simple types. A user may be provided to input the data elements by an appropriate user interface (e.g., using the test page in FIG. 4) and WS client code generator 270 may associate the provided values to the corresponding variables (such as lines 745-748).

WS client code generator 270 includes code portion to invoke the subroutine with the above generated parameter and to store the return value of the subroutine in a newly defined variable “_ret” (line 754). WS client code generator 270 may display the returned value (not shown).

WS client code generator 270 may similarly examine/inspect the entire proxy code 282 to identify the sub-routines to be invoked for testing interoperability and may include corresponding code portions for each identified sub-routine, using similar approach as that described above.

It may be observed that the client code generated contains several program statements (shown as respective lines of FIGS. 7A-7B). WS client code generator 270 forms the program statements automatically. The term “automatically” implies that at least a substantial portion of the program statements are generated programmatically (as opposed to user having to manually specify/code the same). It may be appreciated that the program statements may be formed by incorporating simple/complex data values (either generated by WS client code generator 270, or provided by the user using a web page form, as shown in FIG. 4).

While the above description is provided with respect to combination of .NET environment and C# language, it may be appreciated that WS client code generator 270 can generate client code for other combinations of environment and programming languages.

FIGS. 8A-8B together shows the web service client code emitted (by source emitter 294) for Java Runtime Environment (JRE) and Java programming language. The client code operates to test the two operations “ApplyForLoan” (lines 811-846) and “hello” (lines 848-863) of the web service using the proxy code 282. The client code of FIGS. 8A-8B may be generated similar to the generation of the client code for .Net and C# described above. For example, the classes and methods (including the parameters) in the proxy code shown in Appendix D may be first determined using reflection and the client code may then be generated based on the determined classes and methods/parameters.

4. Digital Processing System

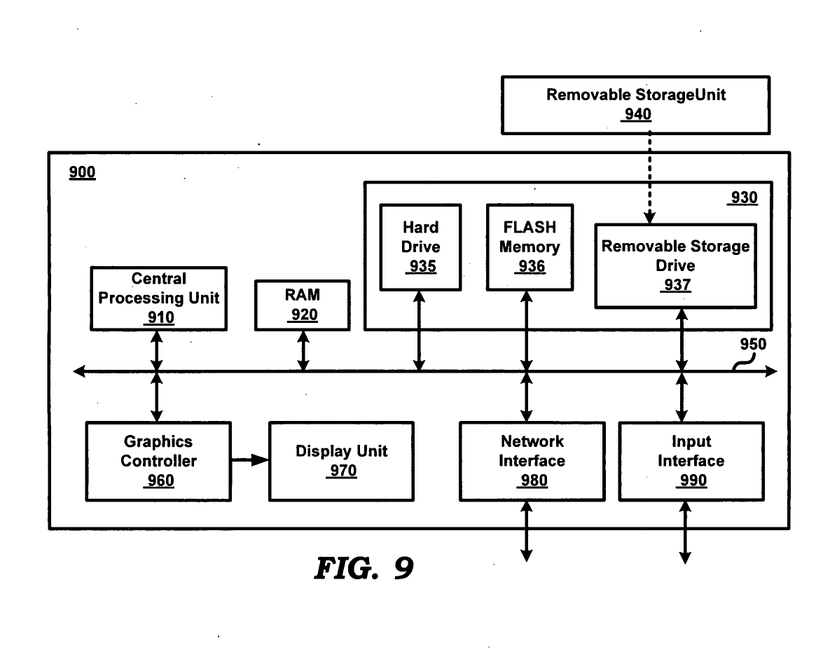

FIG. 9 is a block diagram illustrating the details of digital processing system 900 in which various aspects of the present invention are operative by execution of appropriate software instructions. Digital processing system 900 may correspond to first computing system 200, and second computing system 240. Digital processing system 900 may contain one or more processors (such as a central processing unit (CPU) 910), random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present invention. CPU 910 may contain multiple processing units, with each processing unit potentially being designed for a specific task such as for the Web service client source code generator 270 shown in FIG. 2A. Alternatively, CPU 910 may contain only a single general purpose-processing unit. RAM 920 may receive instructions from secondary memory 930 using communication path 950

Graphics controller 960 generates display signals (e.g., in RGB format) to display unit 970 based on data/instructions received from CPU 910. Display unit 970 contains a display screen to display the images defined by the display signals. For example, the display unit 970 may display the pages of FIGS. 4 and 5. Input interface 990 may correspond to a keyboard and a pointing device (e.g., touch-pad, mouse). Network interface 980 provides connectivity to a network (e.g., using Internet Protocol), and may be used to communicate with others connected systems.

Secondary memory 930 may contain hard drive 935, flash memory 936, and removable storage drive 937. Secondary memory 930 may store the data (e.g., portions of data depicted in Appendices A and B, data specified in FIGS. 4 and 5, etc.) and software instructions (e.g., portions of software code depicted in FIGS. 6A-6C, 7A-7B and 8A-8B, Appendices C and D, etc.), which enable system 900 to provide several features in accordance with the present invention. Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable storage medium having stored therein computer software and/or data. However, the computer (or in general, machine) readable storage medium can be in other forms (e.g., non-removable, random access, etc.).

Further, even though the machine-readable medium is shown as being contained within system 900, it should be appreciated that the medium can be provided external to system 900. In such a case, the instructions may be received, for example, on a network. In addition, some of the aspects can be implemented on a cooperating set of computer systems, even though the system 900 is shown as a single system. The software instructions may accordingly be adapted for such distributed processing.

In this document, the term “computer program product” is used to generally refer to removable storage unit 940 or hard disk installed in hard drive 935. These computer program products are means for providing software to system 900. CPU 910 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

5. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for automatically generating at least one client program for a client application, the client program enabling access to a web service to test interoperability of the client application with the web service, the method comprising:
creating configuration information, the configuration information including data on at least a context for generating the at least one client program for the client application;
analyzing a proxy program, the proxy program designed to enable access to one or more operations provided by the web service;
emitting code for the at least one client program based on the configuration information and on the results of analyzing the proxy program; and
wherein execution of the code causes invocation of a corresponding one or more portions in the proxy program thereby enabling access to corresponding one or more operations provided by the web service.

2. The method of claim 1, wherein the proxy program is generated based on an interface definition of the web service, the interface definition describing at least the one or more operations provided by the web service and wherein, is generated in a programming language supported by the client application execution environment.

3. The method of claim 2, wherein the proxy program comprises a plurality of sub-routines, each sub-routine designed to access corresponding one or more operations provided by the web service.

4. The method of claim 3, further comprising automatically generating test data by analyzing the proxy program and identifying the parameters required for each of the plurality of sub-routines.

5. The method of claim 3, further comprising, automatically generating a test page by analyzing the proxy program and identifying the parameters required by each of the plurality of sub-routines and the generated test page enabling a user to enter test data.

6. The method of claim 4 or claim 5, wherein the emitted code for the at least one client program includes the test data and execution of the code causes invocation of the corresponding one or more portions in the proxy program with the corresponding test data.

7. The method of claim 1, wherein creating the configuration information involves displaying a page to a user enabling selection of the at least one context for generating the at least one client program wherein the at least one context includes at least one policy supported by the web service, thereby enabling interoperability testing in the context of the at least one policy.

8. The method of claim 7, wherein the configuration information includes data indicating the location of the proxy program and data indicating a programming language and an environment of execution of the client application where the at least one client program is to execute.

9. The method of claim 8 wherein emitting the code for the at least one client program further comprises, selecting a source code emitter of a plurality of source code emitters, such that the selected source code emitter generates the at least one client program in the programming language supported for execution on the environment of the client application.

10. The method of claim 1 capable of automatically generating a first client program and a second client program for the client application, wherein the first client program is based on a first set of configuration information and the second client program is based on a second set of configuration information and wherein both the first and second set of configuration information include at least a first context and a second context respectively for generating the first and second client program.

11. The method of claim 1 capable of receiving a first proxy program and a second proxy program designed for a first web service and a second web service respectively, the method further capable of automatically generating a first client program and a second client program for the client application by analyzing respectively, the first proxy program and the second proxy program, to enable interoperability testing of the client application with the first web service and the second web service.

12. The method of claim 1 capable of interoperability testing of multiple client applications with multiple web services by analyzing multiple proxy programs corresponding to each web service and automatically generating multiple client programs for each client application and web service pair in an interoperability test.

13. A system for automatically generating at least one client program for a client application, the client program enabling access to a web service to test interoperability of the client application with the web service, the system comprising:
at least one processor; and
a machine readable medium storing instructions that, when executed by the processor, causes the processor to:
receive configuration information, wherein the configuration information includes data on at least a context for generating the at least one client program for the client application;
analyze a proxy program, the proxy program designed to enable access to one or more operations provided by the web service;
emit code for the at least one client program based on the configuration information and on the results of analysis of the proxy program; and
wherein execution of the emitted code causes invocation of a corresponding one or more portions in the proxy program thereby enabling access to corresponding one or more operations provided by the web service.

14. A computer readable medium carrying one or more sequence of instructions for causing a system to generate a client program to test interoperability with a web service based on a proxy program, said proxy program containing a plurality of sub-routines, wherein each sub-routine is designed to access a corresponding operation provided by said web service, wherein execution of said one or more sequences of instructions by one or more processors contained in said system causes said system to perform the actions of:
receiving an indication that said client program is to be generated;
inspecting said proxy program to identify a first sub-routine contained in said plurality of sub-routines, said first sub-routine designed to access a first operation provided by said web service; and
generating a first portion of said client program, wherein said first portion contains a plurality of program statements, which on execution causes invocation of said first sub-routine, thereby consuming said first operation,
wherein said inspecting and said generating are performed automatically in response to said indication.

15. The computer readable medium of claim 14, wherein said inspecting comprises identifying a first parameter required by said first sub-routine,
wherein said generating generates a set of program statements designed to provide a value for said first parameter and invoke said first sub-routine with said value for said first parameter,
wherein said set of program statements is contained in said plurality of program statements.

16. The computer readable medium of claim 14, wherein said inspecting comprises identifying a second parameter of a complex type required by said first sub-routine, wherein said inspecting further determines a set of variables and a structure by examining said proxy program, said set of variables and said structure together constituting said complex type, wherein each of said set of variables is of a simple type,
wherein said generating generates a second set of program statements designed to provide a corresponding second set of simple values for said set of variables, and to invoke said first sub-routine with said second set of values for said second parameter,
wherein said second set of program statements is contained in said plurality of program statements

17. The computer readable medium of claim 14, further comprising:
retrieving data from a configuration file, said data indicating that said client program is to execute on a client system having a first environment and a first programming language,
wherein said generating generates said client program in said first programming language for execution in said first environment.

18. The computer readable medium of claim 14, wherein said indication corresponds to a situation that said proxy program is generated by a proxy generator based on a WSDL file, said WSDL file defining the operations provided by said web service.
